(19) United States
(12) Patent Application Publication
(10) Pub. No.: US 2015/0039541 A1
(43) Pub. Date: Feb. 5, 2015

(54) Feature Extraction and Machine Learning for Evaluation of Audio-Type, Media-Rich Coursework

(71) Applicant: Kadenze, Inc., Valencia, CA (US)

(72) Inventors: Ajay Kapur, Valencia, CA (US); Perry Raymond Cook, Jacksonville, OR (US); Jordan Hochenbaum, Valencia, CA (US); Owen Skipper Vallis, Valencia, CA (US); Chad A. Wagner, Pasadena, CA (US); Eric Christopher Heep, Val Verde, CA (US)

(21) Appl. No.: 14/448,579

(22) Filed: Jul. 31, 2014

Related U.S. Application Data
(60) Provisional application No. 61/860,375, filed on Jul. 31, 2013.

(51) Int. Cl. G06N 5/04; G06N 99/00

(52) U.S. Cl. CPC G06N 5/04; G06N 99/005
USPC 706/12

(57) ABSTRACT

Conventional techniques for automatically evaluating and grading assignments are generally ill-suited to evaluation of coursework submitted in media-rich form. For courses whose subject includes programming, signal processing or other functionally expressed designs that operate on, or are used to produce media content, conventional techniques are also ill-suited. It has been discovered that media-rich, indeed even expressive, content can be accommodated as, or as derivatives of, coursework submissions using feature extraction and machine learning techniques. Accordingly, in on-line course offerings, even large numbers of students and student submissions may be accommodated in a scalable and uniform grading or scoring scheme. Instructors or curriculum designers may adaptively refine assignments or testing based on classifier feedback. Using developed techniques, it is possible to administer courses and automatically grade submitted work that takes the form of media encodings of artistic expression, computer programming and even signal processing to be applied to media content.

### CROSS-REFERENCE TO RELATED APPLICATIONS

The present application claims priority under 35 U.S.C. §119(e) of U.S. Provisional Application No. 61/860,375, filed Jul. 31, 2013, the entirety of which is incorporated herein by reference.

### BACKGROUND

1. Field of the Invention

The present application is related to automated techniques for evaluating work product and, in particular, to techniques that employ feature extraction and machine learning to efficiently and consistently evaluate instances of media content that constitute, or are derived from, coursework submissions.

2. Description of the Related Art

As educational institutions seek to serve a broader range of students and student situations, on-line courses have become an increasingly important offering. Indeed, numerous instances of an increasingly popular genre of on-line courses, known as Massive Open Online Courses (MOOCs), are being created and offered by many universities, as diverse as Stanford, Princeton, Arizona State University, the Berkeley College of Music, and the California Institute for the Arts. These courses can attract hundreds of thousands of students each. In some cases, courses are offered free of charge. In some cases, new educational business models are being developed, including models in which students may be charged for deeper evaluation and/or credit, or in which advertising provides a revenue stream.

While some universities have created their own Learning Management Systems (LMS), a number of new companies have begun organizing and offering courses in partnership with universities or individuals. Examples of these include Coursera, Udacity, and edX. Still other companies, such as Moodle and Blackboard, offer LMS designs and services for universities who wish to offer their own courses.

Students taking on-line courses usually watch video lectures, engage in blog/chat interactions, and submit assignments, exercises, and exams. Submissions may be evaluated (to lesser or greater degrees, depending on the type of course and nature of the material), and feedback on quality of coursework submissions can be provided. While many courses are offered that evaluate submitted assignments and exercises, the nature and mechanics of the evaluations are generally of four basic types:
1) In some cases, human graders evaluate the exercises, assignments, and exams. This approach is labor intensive, scales poorly, can have consistency/fairness problems and, as a general proposition, is only practical for smaller online courses, or courses where the students are (or someone is) paying enough to hire and train the necessary number of experts to do the grading.
2) In some cases, assignments and exams are crafted in multiple-choice, true false, or fill-in-the blank style, such that grading by machine can be easily accomplished. In some cases, the grading can be instant and interactive, helping students learn as they are evaluated, and possibly shortening the exam time, e.g., by guiding students to harder/easier questions based on responses. However, many types of subject matter, particularly those in which artistic expression or authorship are involved, do not lend themselves to such assignment or examination formats.
3) In some cases, researchers have developed techniques by which essay-style assignments and/or exams may be scanned looking for keywords, structure, etc. Unfortunately, solutions of this type are, in general, highly dependent on the subject matter, the manner in which the tests/assignment are crafted, and how responses are bounded.
4) In some cases, peer-grading or assessment has been used, whereby a student is obligated to grade the work of N other students. Limitations of, and indeed complaints with, peer-assessment include lack of reliability, expertise and/or consistency. Additional issues include malicious or spiteful grading, general laziness of some students, drop-outs and the need to have students submit assignments at the same time, rather than at individual paces.

Improved techniques are desired, particularly techniques that are scalable to efficiently and consistently serve large student communities and techniques that may be employed in subject matter areas, such as artistic expression, creative content computer programming and even signal processing, that have not, to-date, proved to be particularly amenable to conventional machine grading techniques.

### SUMMARY

For courses that deal with media content, such as sound, music, photographic images, hand sketches, video (including videos of dance, acting, and other performances, computer animations, music videos, and artistic video productions), conventional techniques for automatically evaluating and grading assignments are generally ill-suited to direct evaluation of coursework submitted in media-rich form. Likewise, for courses whose subject includes programming, signal processing or other functionally-expressed designs that operate on, or are used to produce media content, conventional techniques are also ill-suited. Instead, it has been discovered that media-rich, indeed even expressive, content can be accommodated as, or as derivatives of, coursework submissions using feature extraction and machine learning techniques. In this way, e.g., in on-line course offerings, even large numbers of students and student submissions may be accommodated in a scalable and uniform grading or scoring scheme. Instructors or curriculum designers may adaptively refine their assignments or testing based on classifier feedback. Using the developed techniques, it is possible to administer courses and automatically grade submitted work that takes the form of media encodings of artistic expression, computer programming and even signal processing to be applied to media content.

In some embodiments in accordance with the present invention(s), a method is provided for use in connection with automated evaluation of coursework submissions. The method includes receiving from an instructor or curriculum designer a selection of exemplary media content to be used in evaluating the coursework submissions. The exemplary media content includes a training set of examples each assigned at least one quality score by the instructor or curriculum designer. The method further includes accessing computer readable encodings of the exemplary media content that together constitute the training set and extracting from each instance of exemplary media content a first set of computationally defined features. The method includes, for each instance of exemplary media content, supplying a classifier with both the instructor or curriculum designer's assigned quality score and values for the computationally defined features extracted therefrom and, based on the supplied quality scores and extracted feature values, training the classifier, wherein the training includes updating internal states thereof. The method further includes accessing a computer readable encoding of media content that constitutes, or is derived from, the coursework submission and extracting therefrom a second set of computationally defined features, applying the trained classifier to the extracted second set of computationally defined features and, based thereon, assigning a particular quality score to the coursework submission.

In some cases or embodiments, plural additional classifiers are supplied with respective instructor or curriculum designer's assigned quality scores and values for computationally defined features extracted from respective instances of the exemplary media content. The additional classifiers are trained and applied as before. In some cases or embodiments, the quality score is, or is a component of, a grading scale for an assignment- or test question-type coursework submission.

In some cases or embodiments, the coursework submission includes software code submitted in satisfaction of a programming assignment or test question, the software code executable to perform, or compilable to execute and perform, digital signal processing to produce output media content. The exemplary media content includes exemplary output media content produced using exemplary software codes, and the particular quality score assigned to the coursework submission is based on the applying of the classifier to the second set of computationally defined features extracted from the output media content produced by execution of the submitted software code.

In some cases or embodiments, the software code coursework submission is executable to perform digital signal processing on input media content to produce the output media content, and the exemplary output media content is produced from the input media content using the exemplary software codes. In some cases or embodiments, the output media content includes audio signals processed or rendered by the software code coursework submission.

In some cases or embodiments, the media content that constitutes, or is derived from, the coursework submission includes an audio signal encoding, and for the first and second sets, at least some of the computationally defined features are selected or derived from: a root mean square energy value; a number of zero crossings per frame; a spectral flux; a spectral centroid; a spectral roll-off measure; a spectral tilt; a mel-frequency cepstral coefficients (MFCC) representation of short-term power spectrum; a beat histogram; and/or a multi-pitch histogram computed over at least a portion of the audio signal encoding.

In some cases or embodiments, the classifier implements an artificial neural network (NN), k-nearest neighbor (KNN), Gaussian mixture model (GMM), support vector machine (SVN) or other statistical classification technique.

In some embodiments, the method further includes iteratively refining the classifier training based on supply of successive instances of the exemplary media content to the classifier and updates to internal states thereof. In some embodiments the method further includes continuing the iterative refining until an error metric based on a current state of classifier training falls below a predetermined or instructor or curriculum designer-defined threshold.

In some cases or embodiments, the classifier is implemented using one or more logical binary decision trees, blackboard voting-type methods, or rule-based classification techniques.

In some embodiments the method further includes supplying the instructor or curriculum designer with an error metric based on a current state of classifier training. In some embodiments the method further includes supplying the instructor or curriculum designer with a coursework task recommendation based on a particular one or more of the computationally defined features that contribute most significantly to classifier performance against the training set of exemplary media content.

In some cases or embodiments, the first and second sets of computationally defined features are the same. In some cases or embodiments, the second set of computationally defined features includes a subset of the first set features selected based on contribution to classifier performance against the training set of exemplary media content. In some cases or embodiments, the quality score is, or is a component of a grading scale for an assignment- or test question-type coursework submission. In some embodiments, the method further includes receiving from the instructor or curriculum designer at least an initial definition of the first set of computationally defined features.

In some embodiments in accordance with the present invention(s), a computational system including one or more operative computers programmed to perform the method of any of foregoing methods. In some cases or embodiments, the computational system is itself embodied, at least in part, as a network deployed coursework submission system, whereby a large and scalable plurality (>50) of geographically dispersed students may individually submit their respective coursework submissions in the form of computer readable information encodings. In some cases or embodiments, the computational system includes a student authentication interface for associating a particular coursework submission with a particular one of the geographically dispersed students.

In some embodiments in accordance with the present invention(s), non-transient computer readable encoding of instructions executable on one or more operative computers to perform any of the foregoing methods.

In some embodiments in accordance with the present invention(s), a coursework management system for automated evaluation of coursework submissions includes an instructor or curriculum designer interface, a training subsystem and a coursework evaluation deployment of a trained classifier. The instructor or curriculum designer interface selects or receives exemplary media content to be used in evaluating the coursework submissions. The exemplary media content includes a training set of examples each assigned at least one quality score by the instructor or curriculum designer. The training subsystem is coupled and programmed to access computer readable encodings of the exemplary media content that together constitute the training set and to extracting from each instance of exemplary media content a first set of computationally defined features. The training subsystem is further programmed to, for each instance of exemplary media content, supply a classifier with both the instructor or curriculum designer's assigned quality score and values for the computationally defined features extracted therefrom, and to, based on the supplied quality scores and extracted feature values, train the classifier, wherein the training includes updating internal states thereof. The coursework evaluation deployment of the trained classifier is coupled and programmed to access a computer readable encoding of media content that constitutes, or is derived from, the coursework submissions and to extract therefrom a second set of computationally defined features. The coursework evaluation deployment applies the trained classifier to the extracted second set of computationally defined features and, based thereon, assigns a particular quality score to the coursework submission.

In some cases or embodiments, the training subsystem supplies plural additional classifiers with respective instructor or curriculum designer's assigned quality scores and values for computationally defined features extracted from respective instances of the exemplary media content and trains the additional classifiers. The coursework evaluation deployment also applies the trained additional classifiers.

In some cases or embodiments, the coursework management system further includes an execution environment. The coursework submission includes software code submitted in satisfaction of a programming assignment or test question. The software code is executable in the execution environment to perform, or compilable to execute in the execution environment and perform, digital signal processing to produce output media content. The exemplary media content includes the output media content produced using the submitted software code. The particular quality score assigned to the coursework submission is based on the applying of the classifier to the second set of computationally defined features extracted from the output media content produced using the submitted software code. In some cases or embodiments, the output media content includes audio signals processed or rendered by the software code coursework submission.

In some cases or embodiments, the classifier implements an artificial neural network (NN), k-nearest neighbor (KNN), Gaussian mixture model (GMM), support vector machine (SVN) or other statistical classification technique. In some cases or embodiments, the training subsystem allows the instructor or curriculum designer to iteratively refine the classifier training based on supply of successive instances of the exemplary media content to the classifier and updates to internal states thereof. In some cases or embodiments, the classifier is implemented using one or more logical binary decision trees, blackboard voting-type methods, or rule-based classification techniques.

In some embodiments in accordance with the present invention(s), a coursework management system includes means for selecting or receiving exemplary media content to be used in evaluating the coursework submissions, the exemplary media content including a training set of examples each assigned at least one quality score by the instructor or curriculum designer; means for extracting from each instance of exemplary media content a first set of computationally defined features, for supplying a classifier with both the instructor or curriculum designer's assigned quality score and values for the computationally defined features extracted therefrom and, based on the supplied quality scores and extracted feature values, for training the classifier; and means for extracting from the coursework submissions a second set of computationally defined features, for applying the trained classifier to the extracted second set of computationally defined features and, based thereon, for assigning a particular quality score to the coursework submission.

### BRIEF DESCRIPTION OF THE DRAWINGS

The present invention may be better understood, and its numerous objects, features, and advantages made apparent to those skilled in the art by referencing the accompanying drawings.

FIG. 1 depicts an illustrative networked information system in which students and instructors (and/or curriculum developers) interact with coursework management systems.

FIG. 2 depicts data flows, interactions with, and operational dependencies of, various components of a coursework management system that provides automated coursework evaluation in accordance with some embodiments of the present invention(s).

FIG. 3 depicts both instructor-side and student-side portions of a feature extraction and machine learning system process flow for media-rich assignments or examinations in accordance with some embodiments of the present invention(s).

The use of the same reference symbols in different drawings indicates similar or identical items.

DESCRIPTION OF THE PREFERRED EMBODIMENT(S)

The computational techniques described herein address practical challenges associated with administration of educational courses or testing, including on-line courses offered for credit to large and geographically dispersed collections of students (e.g., over the Internet), using advanced feature extraction techniques combined with machine learning (ML) algorithms. The developed techniques are particularly well-suited to educational or testing domains in which assignments or test problems call for expressive content, such as sound, music, photographic images, hand sketches, video (including videos of dance, acting, and other performances, computer animations, music videos, and artistic video productions). The developed techniques are also well-suited to educational or testing domains in which assignments or test problems include programming, signal processing or other functionally expressed designs that operate on, or are used to produce media content, and which may be evaluated based on qualities of the media content itself. In each of the foregoing cases, conventional techniques for automatically evaluating and grading assignments (typically multiple choice, true/false or simple fill-in-the-blank or short answer questions) are ill-suited to the direct evaluation of coursework that takes on media-rich forms.

Instead, it has been discovered that media-rich, indeed even expressive, content can be accommodated as, or as derivatives of, coursework submissions using feature extraction and machine learning techniques. In this way, e.g., in on-line course offerings, even large numbers of students and student submissions may be accommodated in a scalable and uniform grading or scoring scheme. Instructors or curriculum designers are provided with facilities to adaptively refine their assignments or testing based on classifier feedback. Using the developed techniques, it is possible to administer courses and automatically grade submitted work that takes the form of media encodings of artistic expression, computer programming and even signal processing to be applied to media content.

### Illustrative System(s) for Automated Coursework Evaluation

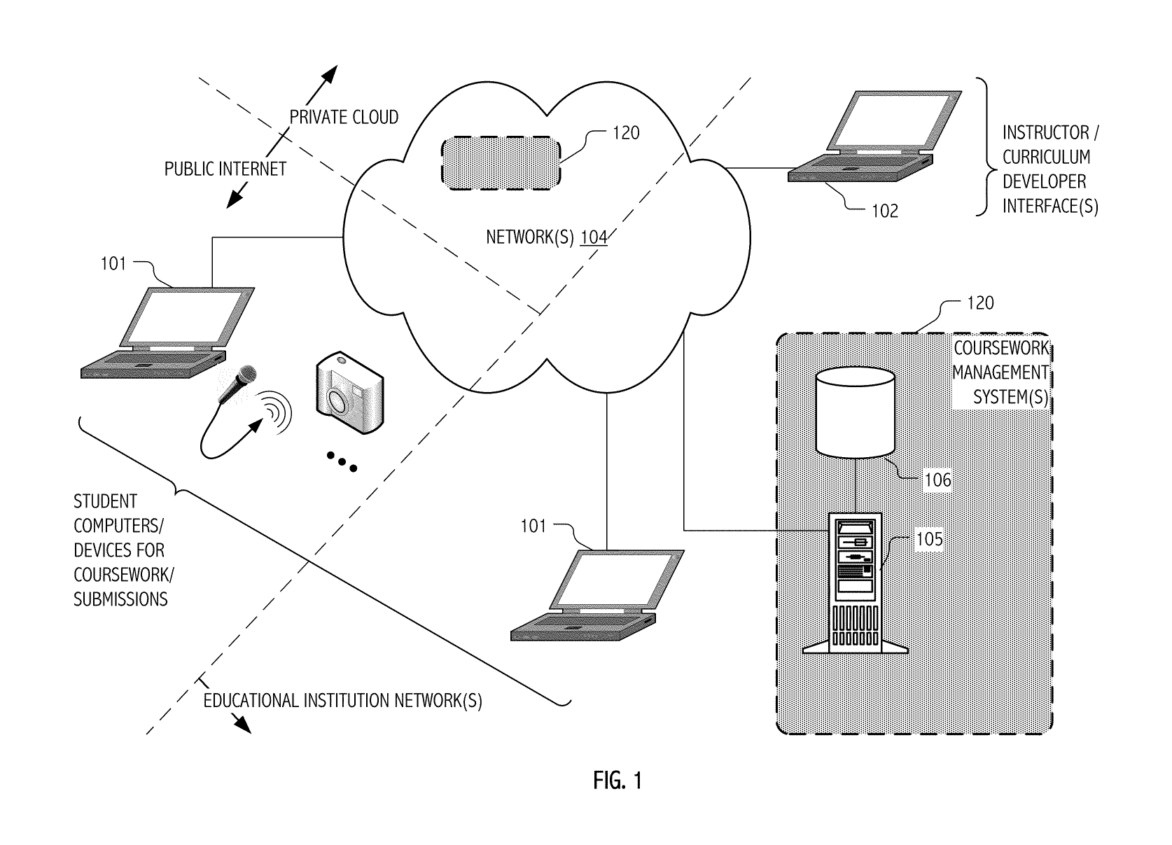

FIG. 1 depicts an illustrative networked information system in which students and instructors (and/or curriculum developers) interact with coursework management systems 120. In general, coursework management systems 120 such as described herein may be deployed (in whole or in part) as part of the information and media technology infrastructure (networks 104, servers 105, workstations 102, database systems 106, including e.g., audiovisual content creation, design and manipulation systems, code development environments, etc. hosted thereon) of an educational institution, testing service or provider, accreditation agency, etc. Coursework management systems 120 such as described herein may also be deployed (in whole or in part) in cloud-based or software-as-a-service (SaaS) form. Students interact with audiovisual content creation, design and manipulation systems, code development environments, etc. deployed (in whole or in part) on user workstations 101 and/or within the information and media technology infrastructure. In many cases, audiovisual performance and/or capture devices (e.g., cameras, microphones, 2D or 3D scanners, musical instruments, digitizers, etc.) may be coupled to or accessed by (or from) user workstations 101 in accordance with the subject matter of particular coursework and curricula.

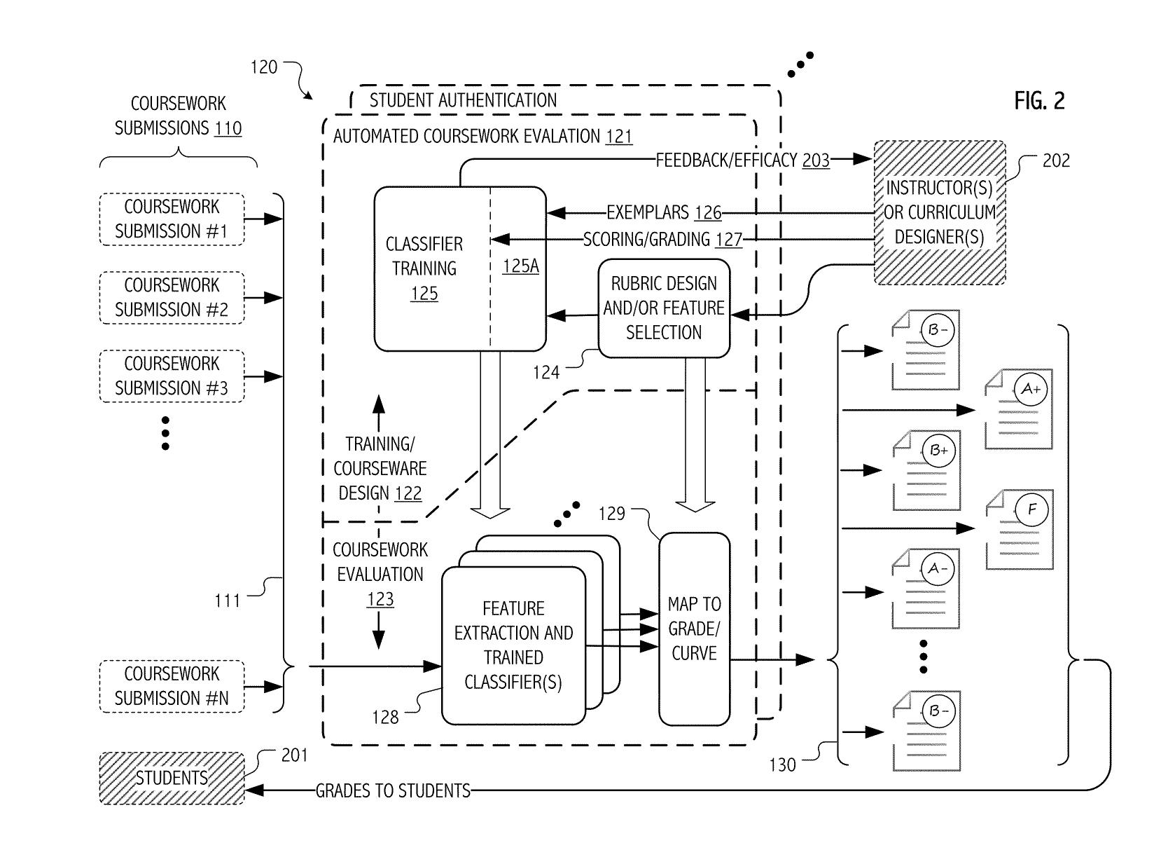

FIG. 2 depicts data flows, interactions with and operational dependencies of various components of an instance of coursework management system 120 that includes an automated coursework evaluation subsystem 121 in accordance with some embodiments of the present invention(s). In particular, automated coursework evaluation subsystem 121 includes a training/courseware design component 122 and a coursework evaluation component 123. An instructor and/or curriculum designer 202 interacts with the training/courseware design component 122 to establish (for given coursework such as a test, quiz, homework assignment, etc.) a grading rubric (124) and to select related computationally-defined features (124) that are to be used to characterize quality or scoring (e.g., in accordance with criteria and/or performance standards established in the rubric or ad hoc) for coursework submissions by students.

For example, in the context of an illustrative audio processing assignment, a rubric may define criteria including distribution of audio energy amongst selected audio sub-bands, degree or quality of equalization amongst sub-bands, degree of panning for mixed audio sources and/or degree or quality of signal compression achieved by audio processing. Based on such a rubric, or in accord with ad hoc selections by instructor and/or curriculum designer 202, particular computationally-defined features are identified that will be extracted (typically) based on signal processing operations performed on media content (e.g., audio signals, images, video, digitized 3D surface contours or models, etc.) and used as input feature vectors in a computational system implementation of a classifier. Instructor and/or curriculum designer 202, also supplies (or selects) media content exemplars 126 and scoring/grading 127 thereof to be used in classifier training 125.

In general, any of a variety of classifiers may be employed in accordance with statistical classification and other machine learning techniques that exhibit acceptable performance in clustering or classifying given data sets. Suitable and exemplary classifiers are identified herein, but as a general proposition, in the art of machine learning and statistical methods, an algorithm that implements classification, especially in concrete and operative implementation, is commonly known as a “classifier.” The term “classifier” is sometimes also used to colloquially refer to the mathematical function, implemented by a classification algorithm that maps input data to a category. For avoidance of doubt, a “classifier,” as used herein, is a concrete implementation of statistical or other machine learning techniques, e.g., as one or more of code executable on one or more processors, circuitry, artificial neural systems, etc. (individually or in combination) that processes instances explanatory variable data (typically represented as feature vectors extracted from instances of data) and groups the instances into categories based on training based on training sets of data for which category membership is known or assigned a priori.

In the terminology of machine learning, classification can be considered an instance of supervised learning, i.e., learning where a training set of correctly identified observations is available. A corresponding unsupervised procedure is known as clustering or cluster analysis, and typically involves grouping data into categories based on some measure of inherent statistical similarity uninformed by training (e.g., the distance between instances, considered as vectors in a multi-dimensional vector space). In the context of the presently claimed invention(s), classification is employed. Classifier training is based on instructor and/or curriculum designer inputs (exemplary media content and associated grading or scoring), feature vectors used characterize data sets are selected by the instructor or curriculum designer (and/or in some cases established as selectable within a training/courseware design module of an automated coursework evaluation system), and data sets are, or are derived from, coursework submissions of students.

Based on rubric design and/or feature selection 124 and classifier training 125 performed (in training/courseware design component 122) using instructor or curriculum designer 202 input, feature extraction techniques and trained classifiers 128 are deployed to coursework evaluation component 123. In some cases, a trained classifier is deployed for each element of an instructor or curriculum designer defined rubric. For example, in the audio processing example described above, trained classifiers may be deployed to map each of the following: (i) distribution of audio energy amongst selected audio sub-bands, (ii) degree or quality of equalization amongst sub-bands, (iii) degree of panning for mixed audio sources and (iv) degree or quality of signal compression achieved by audio processing to quality levels or scores based on training against audio signal exemplars. In some cases, features extracted from media-rich content 111 that constitutes, or is derived from, coursework submissions 110 by students 201 are used as inputs to multiple of the trained classifiers. In some cases, a single trained classifier may be employed, but more generally, outputs of multiple trained classifiers are mapped to a grade or score (129), often in accordance with curve specified by the instructor or curriculum designer.

Resulting grades or scores 130 are recorded for respective coursework submissions and supplied to students 201. Typically, coursework management system 120 includes some facility for authenticating students, and establishing, to some reasonable degree of certainty, that a particular coursework submission 110 is, in fact, submitted by the student who purports to submit it. Student authentication may be particularly important for course offered for credit or as a condition of licensure. While student authentication is not essential to all coursework management system implementations that provide automated coursework evaluation in accord with embodiments of the present invention(s), suitable student authentication techniques are detailed in commonly-owned, co-pending Provisional Application No. 62/000,522, filed May 19, 2014, entitled “MULTI-MODAL AUTHENTICATION METHODS AND SYSTEMS” and naming Cook, Kapur, Vallis and Hochenbaum as inventors, the entirety of which is incorporated herein by reference.

In some embodiments of coursework management system 120 (see e.g., FIG. 2), an automated coursework evaluation subsystem 121 may cooperate with student authentication facilities, such as fraud/plagiarism detection. For example, if coursework submissions (ostensibly from different, separately authenticated students) exhibit exactly or nearly the same score(s) based on extracted computationally defined features and classifications, then fraud or plagiarism is likely and can be noted or flagged for follow-up investigation. Likewise, if a coursework submission exhibits exactly the same score(s) (again based on extracted computationally defined features and classifications) as a grading exemplar or model audio signal, image, video or other expressive media content supplied to the students as an example, then it is likely that the coursework submission is, in-fact, a submission of the example, rather than the student's own work. Based on the description herein, persons of skill in the art will appreciate these and other benefits of integrating student authentication and automated coursework evaluation facilities in some embodiments of a coursework management system.

### Exemplary Use Cases

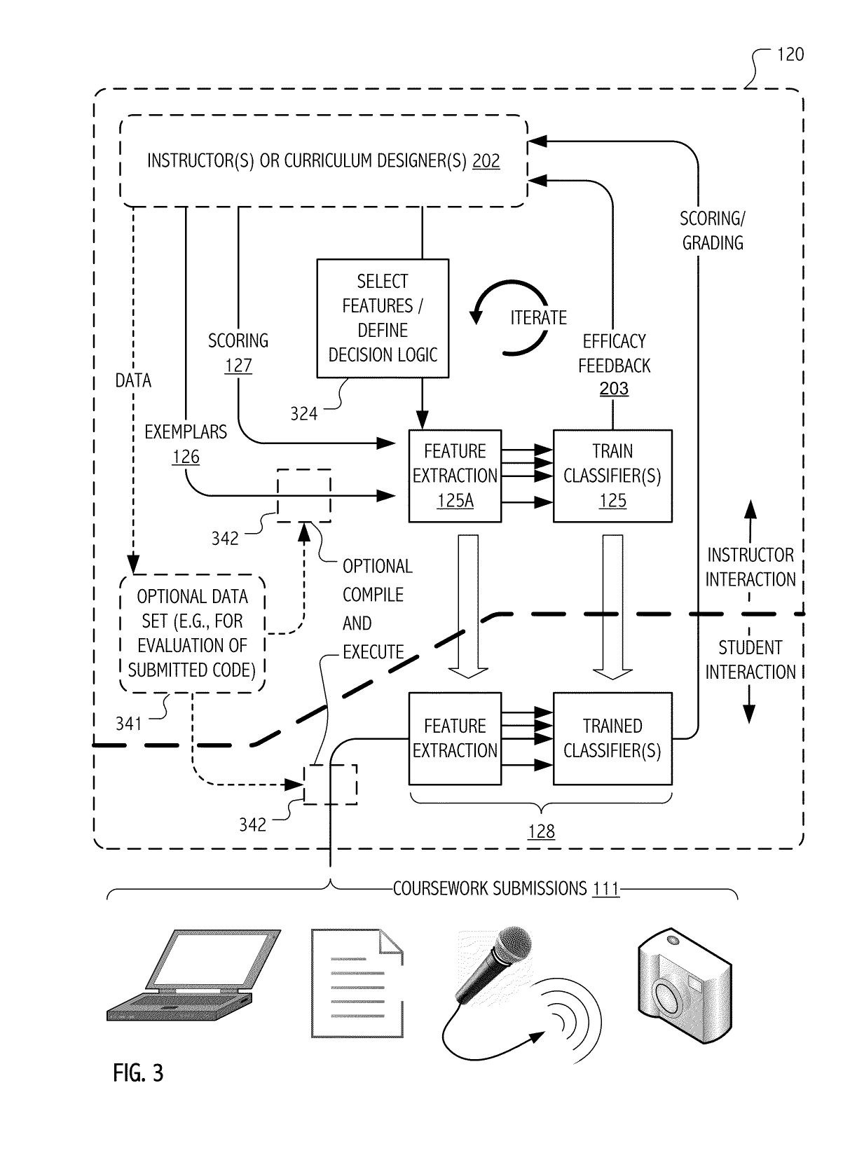

The developed techniques provide instructors and curriculum designers with systems and facilities to add training examples together with grading or scoring characterizations thereof. For example, in some cases or embodiments, an instructor or curriculum designer 202 may identify certain training examples as exemplars (e.g., exemplars 126, see FIGS. 2, 3) of good and bad (or good, mediocre, and bad) coursework submissions that have been scored/graded (or that the instructor or curriculum designer may score/grade) 127. The system extracts (125A) computationally-defined features from the training examples, and uses these extracted features to train (125) a computational system that implements a classifier.

In general, an operative set of feature extractors may be interactively selected or defined (see rubric design/feature selection 124, FIG. 2 and select features/define decision logic 324, FIG. 3) for a particular assignment or test question. In some cases, systems or methods in accordance with the present inventions provide (and/or guide) the instructor or curriculum designer through a menu or hierarchy of feature extractor selections and/or classification stages. In some cases, a decision tree of rules may be automatically derivable from the provided files of good/bad examples. In some cases, it may be desirable to allow the instructor/curriculum designer to identify (or label) what is good or bad about the training examples. For example, in an application of the developed techniques to grading of music coursework submissions, systems and methods may allow the instructor/curriculum designer to note that a training example is (1) in the key of C, (2) has more than 2, but less than 10, discernible sections, (3) has a very strong beat, etc.

The classifier learns to categorize submissions in accordance with the instructor or curriculum designer's classifications (e.g., on a grading scale or against a rubric), and (at least during training) provides the instructor or curriculum designer with feedback (203) as to how well (statistically speaking) submissions will be classified based on the current training. In some cases, the system makes suggestions as to how to change the task or criteria so that submissions are easier to classify and thus grade. In response, the instructor or curriculum designer can modify the assignment or evaluation criteria, resubmitting the original examples or modified ones, until they (and the system) are satisfied that the system will perform well enough for grading student submissions. As illustrated in FIG. 3, at least some embodiments of coursework management system 120, provide an iterative and interactive instructor (or curriculum designer) interaction to identify the set of computationally defined features and to train classifiers for deployment as an automated evaluator (see feature extraction and trained classifiers 128) of coursework submissions suitable for student interactions or use by a course administrator.

“Good” exemplars 126 (i) can come from historical or current masters in the field or can be examples that are representative of the style being emulated, (ii) can be generated by the curriculum designer or (iii) can include previous student submissions from prior administrations of the course (or even hand-picked grading exemplars from a current administration of the course). In some cases or educational domains, initial “bad” exemplars 126 can be provided by the curriculum designer or drawn from student submissions (whether from prior administrations or current exemplars). In some cases, once the system is used to offer a course or evaluate an assignment once, prior training (125) serves as a baseline and hand-selected student submissions are thereafter used to re-train the system, or refine the training, for better results.

Aside from speed and convenience, and the ability to evaluate thousands rather than tens of submissions in a short time can provide significant advantages. Furthermore, in some cases or embodiments, computational capabilities of the classifier may be scaled as needed, e.g., by purchasing additional compute power via cloud services or compute farms. Additional benefits include absolute objectivity and fairness. All assignments can be evaluated by exactly the same rules and trained machine settings. This is not the case with a collection of human examiners, who inevitably bring biases and grow fatigued during/between sessions, yielding inconsistent results.

Often, coursework submissions 111 are presented for automated evaluation as computer readable media encodings uploaded or directly selected by students from their respective workspaces. In some cases, a course administrator may act as an intermediary and present the coursework submissions 111 to the automated coursework evaluation subsystem 121. Suitable encoding formats are dependent on the particular media content domain to which techniques of the present invention are applied and are, in general, matters of design choice. Nonetheless, persons of skill in the art, having benefit of the present disclosure will appreciate use of suitable data access methods and/or codecs to obtain and present media content in data structural forms that are, in turn, suitable or convenient for feature extraction and use as classifier inputs in any particular implementation of the techniques described herein.

### Media-Rich Grading Examples:

Persons of skill in the art having access to the present disclosure will appreciate a wide range of media-rich content for which the described automated grading techniques may be applied or adapted. Nonetheless, as a set of illustrative examples, we summarize computationally-defined features and mappings performed by a trained classifier first for several aspects of an audio processing course rubric and then for a music programming course rubric. Sets of computationally-defined audio features suitable to such courses are also summarized. Finally, we outline an application of similar techniques to media content characteristic of visual art, still images and/or motion video.

### Audio Processing Course Example:

One illustrative example of a media-rich educational domain in which techniques of the present invention may be employed is audio processing, e.g., application of digital signal processing techniques to audio signal encodings. Depending on the course, operative implementations of such techniques may be made available to students in the form of audio processing systems, devices and/or software, or as an audio processing toolset, library, etc. Students may learn to use these operative implementations of signal processing techniques to manipulate and transform audio signals.

For example, in a basic audio processing course, students may be taught audio composition, sub-band equalization, mixing and panning techniques, use and introduction of reverberation, signal compression, etc. In such a course, students may be given assignments or quizzed or tested for mastery of these audio processing techniques. A coursework management system that provides automated evaluation of coursework submissions as described herein may facilitate administration of such a course. Accordingly, based on the description herein, persons of skill in the art will appreciate that systems and techniques detailed above with reference to FIGS. 2 and 3 may be employed or adapted to evaluate coursework submissions that seek to demonstrate student mastery of techniques for manipulating and transforming a reference audio signal. For such a course, a rubric may specify grading of one or more transformed audio signals for levels, equalization, panning and compression.

Grading for Levels and Equalization:

To facilitate grading for levels (and equalization), an instructor or curriculum designer may select or specify computational-defined features that include calculations of RMS power in a transformed audio signal submitted by the student and in various mix-motivated sub-bands thereof. For example, in some cases or situations, RMS power may be calculated in each of the following mix-motivated sub-bands for the submitted audio signal:

| | |
|---|---|
| <40 | Hz (sub) |
| 40-120 | Hz (bass) |
| 120-400 | Hz (low-mid) |
| 400-900 | Hz (mid) |
| 0.9-2.5 | kHz (high-mid) |
| 2.5-6 | kHz (presence) |
| 6-10 | kHz (bite) |
| >10 | kHz (air/sibilance) |

Using such computational-defined features and/or derived mean/variance measures, a classifier (or classifiers) may be trained using scored/graded reference signal exemplars to identify course work submissions that exhibit good, mediocre, and bad leveling from a compositional perspective. Likewise, a classifier (or classifiers) may be trained using scored/graded reference signal exemplars to identify course work submissions that exhibit good, mediocre, and bad equalization of sub-band levels. As will be appreciated, scoring quantization as good, mediocre, and bad is merely illustrative.

Grading for Panning:

To facilitate grading for panning, an instructor or curriculum designer may select or specify features that are computational-defined as follows:
1) Time-align student submitted audio signal with a reference audio signal and slice into beat-aligned segments.
2) Sum the energy in each segment in 24 bark-frequency bands, producing a beat-bark matrix.
3) Calculate channel similarity between Left and Right channels of submitted student audio signal as

$$ψ ( m , k ) = \frac{\vert {X}_{L} ( m , k ) \cdot {X}_{R}^{*} ( m , k ) \vert }{{\vert {X}_{L} ( m , k ) \vert}^{2} + {\vert {X}_{R} ( m , k ) \vert}^{2}}$$

(where m is bark index and k is beat index).
4) Calculate partial similarity measures for each channel as e.g.

$${ψ}_{L} ( m , k ) = \frac{\vert {X}_{L} ( m , k ) \cdot {X}_{R}^{*} ( m , k ) \vert }{{\vert {X}_{L} ( m , k ) \vert}^{2}}$$

$${ψ}_{L} ( m , k ) = \frac{\vert {X}_{L} ( m , k ) \cdot {X}_{R}^{*} ( m , k ) \vert }{{\vert {X}_{L} ( m , k ) \vert}^{2}}$$

These partial similarities are then used to produce a sign function, i.e., −1 if ψ_{L}, (m, k)>ψ_{R}(m, k) and +1 if vice versa.
5) Calculate a final panning index as 1−ψ(m, k) times the sign function.
6) Apply a logistic mask based on signal energy to panning index values to remove contribution from bins with little or no signal energy.
7) Calculate an overall panning score as the total absolute difference between student panning index and reference panning index over all beat-bark bins.
   Using such computational-defined features, a classifier (or classifiers) may be trained using scored/graded reference signal exemplars to identify course work submissions that exhibit good, mediocre, and bad panning. As before, scoring quantization as good, mediocre, and bad is merely illustrative.

Grading for Compression:

To facilitate grading for compression, an instructor or curriculum designer may select or specify features that are computational-defined as follows:
1) Time-align student submitted audio signal with a reference audio signal.
2) Calculate time-domain amplitude envelope of submitted student file by low-pass filtering the squared amplitude (e.g., using a 512-order finite impulse response filter, 40 Hz cutoff, applied forward and then reverse), then taking the square root of half-wave rectified filtered signal.
3) Calculate a difference function between the envelope of the student submitted audio signal and the reference.
4) Compute the average zero-crossing rate, average absolute value, and average absolute first-order difference of the difference function.
   Using such computational-defined features, a classifier (or classifiers) may be trained using scored/graded reference signal exemplars to identify course work submissions that exhibit good, mediocre, and bad compression. As before, scoring quantization as good, mediocre, and bad is merely illustrative.

Grading for Compositional Effort:

Still another example is grading for “compositional effort” (in essence, a computational-defined feature, decision-tree, and classifier-based evaluation of the question “is this music interesting?”). To evaluate compositional effort, we extract features, use them (plus clustering of windows) to segment the submitted audio into sections. Decision tree logic can determine whether the number, and indeed structure, of sections meets objectives specified in the grading rubric. In some cases, we can also compare sections pairwise using computationally-defined features to determine structure (e.g., verse, chorus, verse, chorus, bridge, chorus), and scoring or grading can be assigned based on such determined structure.

### Grading of Music Programming:

A related, and also illustrative, example of a media-rich educational domain in which techniques of the present invention may be employed is music programming, i.e., digital signal processing software as applied to audio encodings of music. In a music programming course, students may be given an assignment to develop a computer program to perform some desired form of audio processing on an audio signal encoding. For example, a student might be assigned the task of developing programming to reduce the dynamic range of an existing audio track (called compression) by computing a running average of the RMS power in the signal, then applying a dynamically varying gain to the signal in order to make louder segments softer, and softer segments louder, thus limiting the total dynamic range.

In support of such an assignment, the systems and methods described herein may perform an initial textual and structural evaluation of the students' submitted coursework (here, computer code). Using lexical and/or syntactic analysis, it is possible to determine conformance with various elements required by the assignment, e.g., use of calling structures and required interfaces, use of particular computational primitives or techniques per the assignment, coding within storage use constraints, etc. Next, the systems and methods may compile the submitted code automatically (e.g., to see if it compiles; if not, the student must re-submit). Once compiled, the coursework submission may be executed against a data set to process audio input and/or generate audio output. Alternatively or in addition, the student's submission itself may include results (e.g., an encoded audio signal) generated by execution of the coursework submission against a data set to process audio input and/or generate audio output. In either case, the audio features are extracted from the audio signal output and supplied to the classifiers of the machine-grading system to produce a grading or score for the coursework submission. See e.g., FIG. 3 and the optional data set 341 (for evaluation of submitted code) and optional compile and executed operations 342 illustrated therein.

### Predefined Audio Feature Extractors and Exemplary Classifier Designs:

Although the selection of particular audio features to extracted may be, in general, assignment- or implementation-dependent (and in some cases or embodiments may be augmented or extended with instructor- or curriculum-defined feature extraction modules), an exemplary set of audio feature extraction modules may be provided for selection by the instructor or curriculum designer. For example, in some cases or embodiments, the following computationally-defined feature extractions may be provided or selected with computations over windows of various size (20, 50, 100 ms, 0.5 s, 1 s typical):
RMS (Root Mean Square) energy of the audio signal;
Number of zero crossings (per frame) in the audio signal;
Spectral flux (frame to frame difference of power spectra, e.g., FFT magnitude) of the audio signal;
Spectral centroid (center of gravity of power spectrum, brightness measure) of the audio signal;
Spectral roll-off frequency for the audio signal (below this freq., X % of total power spectrum energy lies);
Spectral tilt of the audio signal (slope of line fit to power spectrum or log power spectrum);
mel-frequency cepstral coefficients (MFCC) representation of short-term power spectrum for the audio signal (inverse transform of log of power spectrum, warped to Mel freq. scale);
Beat histogram for the audio signal (non-linear autocorrelation-based estimates of music/sonic pulse); and/or
Multi-pitch histograms for the audio signal (extract sinusoids, cluster by harmonicity, calculate pitches).

In general, means and standard deviations of these and/or or other extracted features are computed (often over different windows) and used to characterize sound and music. In some cases, signals may be segmented, and features computationally extracted over contextually-specific segments. Using various metrics, distance functions, and systems, including artificial neural network (NN), k-nearest neighbor (KNN), Gaussian mixture model (GMM), support vector machine (SVN) and/or other statistical classification techniques, sounds/songs/segments can be compared to others from a previously scored or graded database of training examples. By classifying coursework submissions against a computational representation of the scored or graded training examples, individual coursework submissions are assigned a grade or score. In some case or embodiments, features (or feature sets) can be compressed to yield “fingerprints,” making search/comparison faster and more efficient. Based on the description herein, persons of ordinary skill in the art will appreciate both a wide variety of computationally-defined features that may be extracted from the audio signal of, or derived from, a coursework submission and a wide variety of computational techniques for classifying such coursework submissions based on the extracted features.

### OTHER EMBODIMENTS AND VARIATIONS

While the invention(s) is (are) described with reference to various embodiments, it will be understood that these embodiments are illustrative and that the scope of the invention(s) is not limited to them. Many variations, modifications, additions, and improvements are possible. For example, while certain illustrative signal processing and machine learning techniques have been described in the context of certain illustrative media-rich coursework and curricula, persons of ordinary skill in the art having benefit of the present disclosure will recognize that it is straightforward to modify the described techniques to accommodate other signal processing and machine learning techniques, other forms of media-rich coursework and/or other curricula.

Both instructor-side and student-side portions of a feature extraction and machine learning system process flows for media-rich coursework have been described herein in accordance with some embodiments of the present invention(s). In simplified, yet illustrative use cases chosen to provide descriptive context, the instructor or curriculum designer provides a set of exemplars that she scores, classifies or labels as “good” and provides set of exemplars that she scores, classifies or labels as “bad.” The instructor or curriculum, then trains the illustrated computational machine by selecting/pairing features or expressing rules or other decision logic, as needed, to computationally classify the exemplars (and subsequent coursework submissions) in accord with the desired classifications. As will be appreciated by persons of ordinary skill in the art having benefit of the present disclosure, scores, classes or labels of interest may be multi-level, multi-variate, and/or include less crass or facially apparent categorizations. For example, classifiers may be trained to classify in accordance with instructor or curriculum provided scores (e.g., ratings from 0 to 6 on each of several factors, on a 100-point scale or, in some cases, as composite letter grades) or labels (e.g., expert/intermediate/amateur), etc.

Likewise, while audio processing, music programming and extracted audio features are used as an descriptive context for certain exemplary embodiments in accord with the present invention(s), persons of ordinary skill in the art will (based on the present disclosure) also appreciate applications to other media-rich, indeed even expressive, content. For example, turning illustratively to visual art, images and/or video, it will be appreciated that it is possible to compute features from still images, or from a succession of images (video) using similar or at least analogous techniques applied generally as described above. Techniques in this sub-domain of signal processing are commonly referred to as “computer vision” and, as will be appreciated by persons of ordinary skill in these arts having benefit of the present disclosure, analogous features for extraction can include color histograms, 2D Transforms, edges/corners/ridges, curves and curvature, blobs, centroids, optical-flow, etc. In video targeted applications, detection of sections and transitions (fades, cuts, dissolves, etc.) may be used in automated grading, particularly where a rubric asks students to use at least one each of jump-cut, fade, cross-dissolve, or to have at least three separate “scenes”. As with the audio processing examples above, decision tree logic and computationally-defined features may be employed to detect sections and transitions (here, fades, cuts, dissolves, etc.) between sections. If statistics for sections differ, grading/scoring can be based on the presence, character or structure of the sections or transitions and correspondence with the rubric.

As before, means and standard deviations of these and/or or other extracted features are computed (often over different windows) and used to characterize the images or video. Again, extracted feature sets may be used to classify coursework submissions against a graded or scored set of exemplars. Using various metrics, distance functions, and systems, including artificial neural network (NN), k-nearest neighbor (KNN), Gaussian mixture model (GMM), support vector machine (SVN) and/or other statistical classification techniques, images/video segments can be compared to others from a previously scored or graded database of training examples. By classifying coursework submissions against a computational representation of the scored or graded training examples, individual coursework submissions are assigned a grade or score.

Furthermore, as online courses become more popular and are offered for credit, a further concern arises related to verification and authentication of the student taking the course and submitting assignments. Cases of fraud, e.g., where someone is hired to do the work for someone else who will receive credit, must be avoided if possible. Some institutions who offer online for credit require physical attendance at proctored examinations. As online courses expand to offer credit in geographically diverse locations, and as class sizes grow, supervised exams can become impractical or impossible. The techniques implemented by systems described herein can help with this problem, using the same or similar underlying frameworks for voice, face, and gesture recognition. If required, the user can be required to authenticate themself, e.g., via Webcam, with each assignment submission, or a number of times throughout an online exam. In some cases or embodiments, a student authentication may use the same or similar features used to grade assignments to help determine or confirm identity of the coursework submitter For example, in some cases or embodiments, computationally-defined features extracted from audio and/or video provided in response to a “Say your name into the microphone” direction or a “Turn on your webcam, place your face in the box, and say your name” requirement may be sufficient to reliably establish (or confirm) identity of an individual taking a final exam based, at least in part, on data from earlier coursework submissions or enrollment.

Embodiments in accordance with the present invention(s) may take the form of, and/or be provided as, a computer program product encoded in a machine-readable medium as instruction sequences and other functional constructs of software, which may in turn be executed in a computational system to perform methods described herein. In general, a machine readable medium can include tangible articles that encode information in a form (e.g., as applications, source or object code, functionally descriptive information, etc.) readable by a machine (e.g., a computer, server, virtualized compute platform or computational facilities of a mobile device or portable computing device, etc.) as well as non-transitory storage incident to transmission of the information. A machine-readable medium may include, but is not limited to, magnetic storage medium (e.g., disks and/or tape storage); optical storage medium (e.g., CD-ROM, DVD, etc.); magneto-optical storage medium; read only memory (ROM); random access memory (RAM); erasable programmable memory (e.g., EPROM and EEPROM); flash memory; or other types of medium suitable for storing electronic instructions, operation sequences, functionally descriptive information encodings, etc.

In general, plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the invention(s).

What is claimed is:

1. A method for use in connection with automated evaluation of coursework submissions, the method comprising:
receiving from an instructor or curriculum designer a selection of exemplary media content to be used in evaluating the coursework submissions, the exemplary media content including a training set of examples each assigned at least one quality score by the instructor or curriculum designer;
accessing computer readable encodings of the exemplary media content that together constitute the training set and extracting from each instance of exemplary media content a first set of computationally defined features;
for each instance of exemplary media content, supplying a classifier with both the instructor or curriculum designer's assigned quality score and values for the computationally defined features extracted therefrom;
based on the supplied quality scores and extracted feature values, training the classifier, wherein the training includes updating internal states thereof;
accessing a computer readable encoding of media content that constitutes, or is derived from, the coursework submission and extracting therefrom a second set of computationally defined features; and
applying the trained classifier to the extracted second set of computationally defined features and, based thereon, assigning a particular quality score to the coursework submission.

2. A method as in claim 1, further comprising:
supplying plural additional classifiers with respective instructor or curriculum designer's assigned quality scores and values for computationally defined features extracted from respective instances of the exemplary media content;
training the additional classifiers; and
applying the trained additional classifiers.

3. A method as in claim 1,
wherein the quality score is, or is a component of, a grading scale for an assignment- or test question-type coursework submission.

4. A method as in claim 1,
wherein the coursework submission includes software code submitted in satisfaction of a programming assignment or test question, the software code executable to perform, or compilable to execute and perform, digital signal processing to produce output media content;
wherein the exemplary media content includes exemplary output media content produced using exemplary software codes; and
wherein the particular quality score assigned to the coursework submission is based on the applying of the classifier to the second set of computationally defined features extracted from the output media content produced by execution of the submitted software code.

5. A method as in claim 4,
wherein the software code coursework submission is executable to perform digital signal processing on input media content to produce the output media content; and
wherein the exemplary output media content is produced from the input media content using the exemplary software codes.

6. A method as in claim 1,
wherein the media content that constitutes, or is derived from, the coursework submission includes an audio signal encoding; and
wherein for the first and second sets, at least some of the computationally defined features are selected or derived from:
a root mean square energy value;
a number of zero crossings per frame;
a spectral flux;
a spectral centroid;
a spectral roll-off measure;
a spectral tilt;
a mel-frequency cepstral coefficients (MFCC) representation of short-term power spectrum;
a beat histogram; and/or
a multi-pitch histogram
computed over at least a portion of the audio signal encoding.

7. A method as in claim 1,
wherein the classifier implements an artificial neural network (NN), k-nearest neighbor (KNN), Gaussian mixture model (GMM), support vector machine (SVN) or other statistical classification technique.

8. A method as in claim 1, further comprising:
iteratively refining the classifier training based on supply of successive instances of the exemplary media content to the classifier and updates to internal states thereof.

9. A method as in claim 1,
wherein the classifier is implemented using one or more logical binary decision trees, blackboard voting-type methods, or rule-based classification techniques.

10. A method as in claim 8, further comprising:
continuing the iterative refining until an error metric based on a current state of classifier training falls below a predetermined or instructor or curriculum designer-defined threshold.

11. A method as in claim 1, further comprising:
supplying the instructor or curriculum designer with an error metric based on a current state of classifier training.

12. A method as in claim 1, further comprising:
supplying the instructor or curriculum designer with a coursework task recommendation based on a particular one or more of the computationally defined features that contribute most significantly to classifier performance against the training set of exemplary media content.

13. A method as in claim 1,
wherein the first and second sets of computationally defined features are the same.

14. A method as in claim 1,
wherein the second set of computationally defined features includes a subset of the first set features selected based on contribution to classifier performance against the training set of exemplary media content.

15. A method as in claim 1,
wherein the quality score is, or is a component of a grading scale for an assignment- or test question-type coursework submission.

16. A method as in claim 1, further comprising:
receiving from the instructor or curriculum designer at least an initial definition of the first set of computationally defined features.

17. A computational system including one or more operative computers programmed to perform the method of claim 1.

18. The computational system of claim 17 embodied, at least in part, as a network deployed coursework submission system, whereby a large and scalable plurality (>50) of geographically dispersed students may individually submit their respective coursework submissions in the form of computer readable information encodings.

19. The computational system of claim 18 including a student authentication interface for associating a particular coursework submission with a particular one of the geographically dispersed students.

20. A non-transient computer readable encoding of instructions executable on one or more operative computers to perform the method of claim 1.

21. A coursework management system for automated evaluation of coursework submissions, the system comprising:
an instructor or curriculum designer interface for selecting or receiving exemplary media content to be used in evaluating the coursework submissions, the exemplary media content including a training set of examples each assigned at least one quality score by the instructor or curriculum designer;
a training subsystem coupled and programmed to access computer readable encodings of the exemplary media content that together constitute the training set and to extracting from each instance of exemplary media content a first set of computationally defined features;
the training subsystem further programmed to, for each instance of exemplary media content, supply a classifier with both the instructor or curriculum designer's assigned quality score and values for the computationally defined features extracted therefrom, and to, based on the supplied quality scores and extracted feature values, train the classifier, wherein the training includes updating internal states thereof; and
a coursework evaluation deployment of the trained classifier coupled and programmed to access a computer readable encoding of media content that constitutes, or is derived from, the coursework submissions and to extract therefrom a second set of computationally defined features, wherein the coursework evaluation deployment applies the trained classifier to the extracted second set of computationally defined features and, based thereon, assigns a particular quality score to the coursework submission.

22. The coursework management system as in claim 21,
wherein the training subsystem supplies plural additional classifiers with respective instructor or curriculum designer's assigned quality scores and values for computationally defined features extracted from respective instances of the exemplary media content and trains the additional classifiers; and
wherein coursework evaluation deployment also applies the trained additional classifiers.

23. The coursework management system as in claim 21, further comprising:
an execution environment,
wherein the coursework submission includes software code submitted in satisfaction of a programming assignment or test question, the software code executable in the execution environment to perform, or compilable to execute in the execution environment and perform, digital signal processing to produce output media content;
wherein the exemplary media content includes the output media content produced using the submitted software code; and
wherein the particular quality score assigned to the coursework submission is based on the applying of the classifier to the second set of computationally defined features extracted from the output media content produced using the submitted software code.

24. The coursework management system as in claim 23,
wherein the output media content includes audio signals processed or rendered by the software code coursework submission.

25. The coursework management system as in claim 21,
wherein the classifier implements an artificial neural network (NN), k-nearest neighbor (KNN), Gaussian mixture model (GMM), support vector machine (SVN) or other statistical classification technique.

26. The coursework management system as in claim 21,
wherein the training subsystem allows the instructor or curriculum designer to iteratively refine the classifier training based on supply of successive instances of the exemplary media content to the classifier and updates to internal states thereof.

27. The coursework management system as in claim 21,
wherein the classifier is implemented using one or more logical binary decision trees, blackboard voting-type methods, or rule-based classification techniques.

28. A coursework management system comprising:
means for selecting or receiving exemplary media content to be used in evaluating the coursework submissions, the exemplary media content including a training set of examples each assigned at least one quality score by the instructor or curriculum designer;
means for extracting from each instance of exemplary media content a first set of computationally defined features, for supplying a classifier with both the instructor or curriculum designer's assigned quality score and values for the computationally defined features extracted therefrom and, based on the supplied quality scores and extracted feature values, for training the classifier; and
means for extracting from the coursework submissions a second set of computationally defined features, for applying the trained classifier to the extracted second set of computationally defined features and, based thereon, for assigning a particular quality score to the coursework submission.
